(19) United States
(12) Patent Application Publication
(10) Pub. No.: US 2013/0215992 A1
(43) Pub. Date: Aug. 22, 2013

(54) RECEIVER ADAPTATION BASED ON ACQUIRED PRECODER KNOWLEDGE

(71) Applicants: Muhammad Kazmi, Bromma (SE); Stefania Sesia, Roquefort Les Pins (FR)

(72) Inventors: Muhammad Kazmi, Bromma (SE); Stefania Sesia, Roquefort Les Pins (FR)

(21) Appl. No.: 13/394,190

(22) PCT Filed: Feb. 21, 2012
(86) PCT No.: PCT/SE12/50189

§ 371 Date: Jun. 4, 2012

(51) Int. Cl. H04B 7/06

(52) U.S. Cl. 375/295

(57) ABSTRACT

A user equipment, UE, (14) and a radio network node (12) can perform multiple input multiple output, MIMO, communication. The UE determines a precoder (50, 54) used in the radio network node for transmitting signals from multiple transmit antennas to the UE. Based on the determined precoder used, the UE determines receiver parameters (22, 60A, 60B) for receiving MIMO signals from the radio network node, and configures the UE to receive MIMO signals from the radio network node in accordance with the determined receiver parameters. The radio network node may provide information for transmission to the UE indicating the precoder used in the radio network node to permit the UE to determine a receiver configuration for receiving MIMO signals based on the determined precoder used by the radio network node.

### TECHNICAL FIELD

The technology relates to radio communications, and in particular, to multiple input multiple output (MIMO) communications.

### BACKGROUND

Multiple input multiple output (MIMO) is an advanced antenna technique to improve the spectral efficiency and to thereby boost overall system capacity. In cellular radio communications, a MIMO communication means that one or both of a base station and a user radio terminal called a user equipment (UE) employ multiple antennas. There can be a MIMO communication for example between a base station that employs multiple antennas and a UE that uses only one antenna. There are a variety of MIMO techniques or modes such as Per Antenna Rate Control (PARC), Selective PARC (S-PARC), transmit diversity, receiver diversity, Double Transmit Antenna Array (D-TxAA), etc. The D-TxAA is an advanced version of transmit diversity used in Wideband Code Division Multiple Access (WCDMA).

Irrespective of the MIMO technique, the notation (M×N) is generally used to represent a MIMO configuration in terms number of transmit antennas (M) and receive antennas (N). Common MIMO configurations used or currently discussed for various technologies include: (2×1), (1×2), (2×2), (4×2), (8×2), and (8×4). The MIMO configurations represented by (2×1) and (1×2) are special cases of MIMO and they correspond to transmit diversity and receiver diversity, respectively. The configuration (2×2) will be used in WCDMA release 7. In particular, the WCDMA Frequency Division Duplex (FDD) release 7 will support double transmit antenna array (D-TxAA) in the downlink, which is a multiple input multiple output (MIMO) technique to enhance capacity as described in 3GPP TS 25.214, “Physical layer procedures (FDD).” The Evolved-Universal Terrestrial Radio Access Network (E-UTRAN) downlink will support several MIMO schemes including MIMO techniques as described in 3GPP TS 25.101, “User Equipment (UE) radio transmission and reception (FDD),” including SU-MIMO and MU-MIMO. MIMO technology is also adopted in other wireless communication standards, e.g., IEEE 802.16.

The MIMO modes or other MIMO techniques enable some sort of spatial processing of the transmitted and received signals. This spatial diversity in general improves spectral efficiency, extends cell coverage, enhances user data rate, mitigates multi-user interference, etc. Each MIMO technique has benefits. For example, receiver diversity (1×2) improves the coverage, and (2×2) MIMO, such as D-TxAA, increases peak user bit rate.

The possibility for a 2×2 MIMO scheme to double the data rate achieved in single link conditions depends on whether the channel is sufficiently uncorrelated so that the rank of a 2×2 MIMO channel matrix is 2 (the rank is the number of independent rows or columns of the matrix). However, the average data rate is typically lower than 2 times the data rate achieved in single link conditions.

Although MIMO typically increases complexity and UE battery consumption, MIMO transmission is still attractive for high rate data applications. In WCDMA, the high rate data is mapped onto a downlink shared channel (HS-DSCH) transmitted using MIMO. Embedded or in-band higher layer signaling, e.g., multiplexed on the HS-DSCH, may therefore also be transmitted using MIMO. On the other hand, separate signaling or channels containing dedicated physical or higher layer signaling can be transmitted with MIMO, i.e., using a conventional single antenna technique. In WCDMA, for example, power control is orchestrated via an associated dedicated channel, which sometimes carries higher layer signaling. In soft handover situations, low bit rate dedicated channels may also be beneficially transmitted using one antenna.

MIMO may become a general UE capability since it offers significantly better performance compared to the baseline scenario of a single transmit and receive antenna. A UE supporting MIMO generally informs the network of its MIMO capability at the time of call setup or during registration. Certain technology may support more than one MIMO mode. In one scenario, a base station may support all possible MIMO modes allowed by the corresponding standard, e.g., 3GPP. In another scenario, the base station may offer only a sub-set of those MIMO modes, and in the basic arrangement, the base station may not offer any MIMO operation and support only a single transmit antenna. Ultimately, the actual MIMO technique or mode used depends on whether it is supported by both the serving base station and the UE.

Release-8 (rel-8) of 3GPP introduces new UE capabilities including Multi-Carrier (MC) High Speed Packet Access (HSDPA), where the UE receives a signal on multiple carriers in the same time. Multi-carrier HSDPA can be also deployed with MIMO on each carrier to further enhance the data rate. In many densely populated areas, such as hotspots, an operator may deploy more than one cell in the same geographical area, e.g., several cells in one sector. Each base station (e.g., Node B) may in this situation provide coverage to 3 sectors. As an example, a deployment with 2 carriers per Node B corresponds to 2 co-located “cells” per sector and 6 cells per Node B. In a UTRAN system, this corresponds to multiple cells of 5 MHz each as shown in FIG. 1. Such cells are also referred to as “co-located cells.” The co-located cells are served by the same base station or the Node B. A similar arrangement may be found in E-UTRAN, where due to variability in carrier frequency, the co-located cells may have different bandwidths, and therefore, those cells have different maximum transmission power levels. An example is shown in FIG. 2. Still, even in E-UTRAN, the co-located cells with the same bandwidth will likely be a common deployment scenario. The MIMO technology to which this application is directed is applicable to multi-carrier capable UEs.

Base station maximum power setting is also a concern in MIMO scenarios because the total transmitted power per cell is limited. So the maximum power available in a cell is split between the transmit antennas. A maximum base station power matrix may be determined. Assume there are K co-located cells (or frequency carriers) and L antennas associated with a base station (e.g., a Node B or an eNode B). Let the maximum power set per antenna “j” for a given carrier frequency “i” at a base station BS be denoted by Pᵢⱼ. Let Mₘₐₓ^{BS} denote the maximum base station power matrix for the base station (BS) on linear scale. The maximum total base station power (Pₘₐₓ^{BS}) can be expressed as follows:

$${M}_{max}^{BS} = [ \begin{matrix}{p}_{11} & {p}_{12} & … & {p}_{1 L} \\ {p}_{21} & {p}_{22} & … & {p}_{2 L} \\ ⋮ & ⋮ & ⋮ & \\ {p}_{K 1} & {p}_{K 2} & … & {p}_{KL}\end{matrix} ] \qquad ( 1 )$$

The total maximum transmitted power of all the antennas for a particular carrier frequency ‘i’ can be expressed as follows:

$${\sum }_{j = 1}^{L} {p}_{ij} = {P}_{max}^{i} \qquad ( 2 )$$

The total maximum transmitted power of all the antennas and of all the available carrier frequencies within the base station (BS) can be expressed as follows:

$${\sum }_{i = 1}^{K} {P}_{max}^{i} = {P}_{max}^{BS} \qquad ( 3 )$$

Although there is also a limitation of total maximum transmitted power per antenna over all the carriers, the transmit power between different carriers transmitted from the same antenna can by varied, e.g., by have a multi-carrier power amplifier (MCPA) in the transmitter allocate different maximum power budgets on different carriers on the same antenna. But allocating more different maximum power for one carrier per antenna requires “stealing” that extra maximum power budget from another one carrier.

Cell downlink coverage may be determined by the setting of common channel power levels. When the base station uses MIMO, common channels, such as a broadcast channel (BCH) and a synchronization channel (SCH), containing pilot sequences are generally transmitted from all antennas or at least more than one antenna. However, the power setting can be different on different antennas. For instance, one of the antennas can be regarded as the primary antenna. On the primary antenna, the transmit power of the common pilot sequence (e.g., Common PIlot Channel (CPICH) in WCDMA) can be larger than the transmit power used on any of the remaining antennas. In case of (2×2) MIMO, in a typical arrangement in WCDMA, the CPICH power on the primary antenna can be twice that of the CPICH power set on the secondary antenna. This helps to ensure good cell coverage for non-MIMO UEs, which are served by the primary antenna alone.

The UE identifies cells and estimates the channel from the pilot sequences sent on the common channels (e.g., SCH, CPICH etc). Further, important radio resource functions like cell re-selection, handover decisions, etc. are also based on UE measurements performed on the signals sent via the common channels. Even if the maximum power per antenna is varied, the total transmit power for each of the common channels over all the antennas remains fixed.

Currently, MIMO is defined in 3GPP considering the following characteristics: the Primary CPICH is used as a phase reference for the 1^{st} antenna, the Secondary CPICH is used as a phase reference for the 2^{nd} antenna, a High Speed-Physical Downlink Shared Channel (HS-PDSCH) for MIMO UEs is mapped on the 1^{st} and 2^{nd} antenna, and all the control channels are mapped on both the 1^{st} and 2^{nd} antenna via the use of the Space Time Transmit Diversity (STTD) algorithm. Non-MIMO UE data is mapped only on the 1^{st} antenna.

When such characteristics are considered, depending on the number of non-MIMO UEs, the two transmit antennas at the base station see a highly imbalanced power, which can be a problem for the base station. This is problematic for the base station because it implies unequal power amplifier load, which requires independent control of power on the two power amplifiers. In order to avoid degradation of the performance, the base station must calibrate the two branches with very high accuracy. This increases complexity in the base station. Moreover, the unequal power may have impact on errors due to phase discontinuity, (i.e., caused by independent switching points of operation for the two power amplifiers), of signals between the transmission branches. This may lead to further degradation of the performance, e.g., loss of downlink throughput. 3GPP specified the use of the STTD algorithm for control channels in a MIMO mode in order to limit the power imbalance problem between the two base station transmit antennas. Unfortunately, the STTD algorithm does not perform well in a WCDMA system. As a result, a device called a common precoder is being considered that balances the power transmitted through the two transmit antennas. The common precoder device can be represented mathematically by a matrix with unit-norm elements, i.e., phases, and effectively balances the power between the two antennas so that the two antennas transmit at the same or substantially the same power.

A problem is that a UE is not aware of that the base station is using a precoder or what type of precoder the base station is using. As a result, the UE can not take actions that would improve its performance and that of the system. If the UE knew that the base station is using or is not using a precoder, and what type of precoder is being used, then the UE can achieve better performance, reduce UE complexity, and/or reduced battery power consumption.

### SUMMARY

A user equipment (UE) radio node perform multiple input multiple output (MIMO) communications with a radio network node that includes multiple MIMO branches. Each MIMO branch includes a power amplifier (32) and an antenna (34). The UE determines a precoder used in the radio network node for transmitting signals from multiple transmit antennas to the user equipment. Based on the determined precoder used in the radio network node, the UE determines receiver parameters for receiving MIMO signals from the radio network node. The UE is configured to receive MIMO signals from the radio network node in accordance with the determined receiver parameters.

In one example embodiment, the determining of the precoder used in the radio network node includes whether the radio network node uses a common precoder that enables each of the MIMO branches to transmit with the same power, or alternatively precoder that enables each of the MIMO branches to transmit with a different power or with a power offset between MIMO signals transmitted by the radio network node. A message may be received indicating whether the radio network node is using the common precoder in MIMO transmissions. The message in one example implementation may indicate the precoder used in a serving and/or neighboring radio network node. In another example embodiment, the message further includes a time period associated with using the common precoder in the radio network node.

The message may be received for example over a control channel or a data channel and/or may originate from one or more network nodes including the radio network node, a radio network controller, a base station controller, base station, Node B, eNode B, or a relay node.

In an example implementation, the determining includes estimating precoder weights used by the network node based on channel estimates.

The UE may include a first type of receiver and a second type of receiver that is more robust and/or more accurate than the first type of receiver. In that example case, configuring the UE to receive MIMO signals from the radio network node in accordance with the determined receiver parameters includes selecting one of the first receiver and a second receiver. The first receiver may be selected to receive MIMO signals from the network node if the network node is using a common precoder, and otherwise the second receiver may be selected to receive MIMO signals from the network node if the network node is not using a common precoder.

One goal for determining the precoder used by the radio network node is to improve reception of the received MIMO signals from the network node.

Another aspect of the technology relates to a network node that facilitates multiple input multiple output (MIMO) communications with a user equipment (UE) radio node. A precoder used in a radio network node for transmitting signals from multiple transmit antennas to the UE is determined, and information for transmission to the UE indicating the precoder used in the radio network node is provided to permit the UE to determine a receiver configuration for receiving MIMO signals from the radio network node based on the determined precoder used by the radio network node.

Determining a precoder used in a radio network node may be involve receiving information from the radio network node. The radio network node sending information regarding the precoder used in the radio network node, in one example implementation, is a serving radio network node and/or a neighboring radio network node of the UE.

The information may be provided by one or more of a radio network controller, the radio network node, or another radio network node.

The radio network node includes multiple MIMO branches, and each MIMO branch includes a power amplifier and an antenna. Determining that the radio network node is using a common precoder enables the each of the MIMO branches to transmit with the same power or with a power offset between the MIMO branches in example embodiments.

The provided information may be regarding precoding weights of the precoder or codebook information associated with the precoder in example embodiments.

The information indicating the precoder used in the radio network node to the UE may be sent using one or both of (1) communications protocol layer 3 or above signaling and (2) communications protocol layer 1 or communications protocol layer 2 signaling.

In another example embodiment, the network node sends to the UE configuration information including multiple different precoding capabilities, and subsequently sends to the UE an identifier to identify one of the multiple precoding capabilities currently in use by the network node.

The network node may be one of a radio network controller, a radio base station, a base station controller, a Node B, an eNode B, or a relay node.

### BRIEF DESCRIPTION OF THE DRAWINGS

FIG. 1 illustrates an example of co-located cells in UTRAN or E-UTRAN;

FIG. 2 illustrates an example of co-located cells in E-UTRAN;

FIG. 3 is a non-limiting example radio communications system;

FIG. 4 is a diagram illustrating non-limiting example function block elements for a UE;

FIG. 5 is a diagram illustrating non-limiting example function block elements for a base station;

FIG. 6 is a non-limiting example of a common precoder;

FIGS. 7A and 7B are non-limiting examples of uncommon precoders;

FIG. 8 is a non-limiting example of a base station with selectable common and uncommon precoders and a UE with selectable receivers A and B;

FIG. 9 is a flowchart illustrating non-limiting example procedures followed by a UE; and

FIG. 10 is a flowchart illustrating non-limiting example procedures followed by a base station.

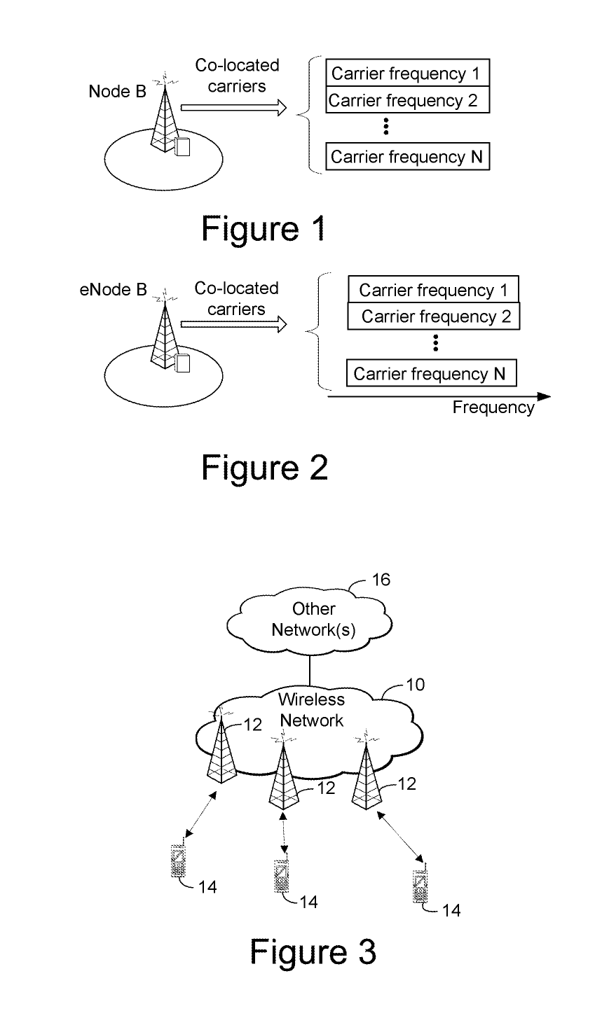

### DETAILED DESCRIPTION

The following description sets forth specific details, such as particular embodiments for purposes of explanation and not limitation. But it will be appreciated by one skilled in the art that other embodiments may be employed apart from these specific details. In some instances, detailed descriptions of well known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

Although the technology described below may be implemented in any appropriate type of radio communication system supporting any suitable communication standards and using any suitable components, particular example embodiments may be implemented in a non-limiting example radio communications system like that illustrated in FIG. 3. One or more user equipment (UEs) 14 and one or more base stations 12 can communicate over a radio interface either directly or via one or more additional elements like a relay node, additional smaller base stations like pico and/or home base stations. The base stations 12 are part of a radio access network (RAN) 10 and are typically coupled to one or more other networks 16 to permit communication with other devices like telephones, computers, web-sites, etc. The UEs and base stations may include hardware alone or hardware in combination with software.

The technology provides information to UE about a precoder used by a radio network node, e.g., a base station, so that the UE can take appropriate action to receive information transmitted from the base station using multiple antennas based on the used precoder. The UE can determine that information in any suitable manner. One non-limiting example is that the radio network node signals that information about the presence of the common precoder to the UE. Alternatively, the UE may itself detect weights used by the radio network node to implement a precoder used for transmitting signals to the UE. The radio network node may also signal information to the UE about the weights used by the radio network node to implement the precoder. In response to the information, the UE adapts, configures, or selects an appropriate receiver configuration, receiver type, etc. to receive signals transmitted by the radio network node using multiple transmit antennas. The receiver adaptation, configuration, or selection is based on the determined the type of precoder used in the radio network node. For example, a first type of receiver type A is selected if one type of precoder is used; otherwise, another type of receiver B is selected. The UE may also acquire additional information about the radio network node precoder to improve reception. One example of such additional acquired information is phases used to implement the precoder. By knowing the precoder used at the radio network node, the UE can achieve better performance, reduce UE complexity, and/or reduced battery power consumption.

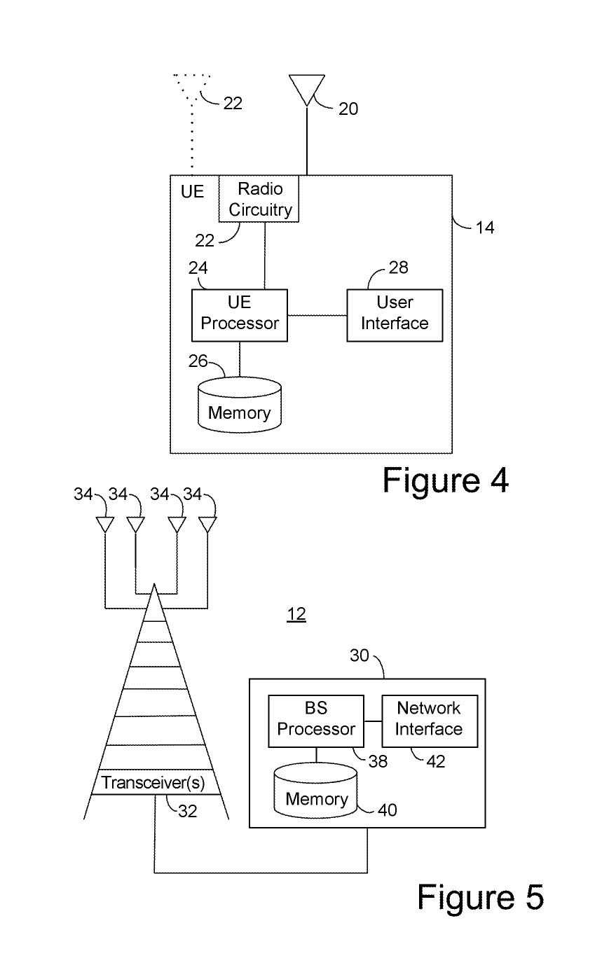

FIG. 4 is a diagram illustrating non-limiting example function block elements for a UE 14. The example UE 14 includes one or more processors 24, one or more memories 26, radio circuitry 20 including one or more radio transceivers with one or more power amplifiers (PA(s)), one or more antennas 22, and user interface 28. The radio circuitry 20 is configurable by the one or more processors 24 to adopt one of multiple receiver configurations implemented in hardware alone or a combination of hardware and software depending on a type of precoder used in the base station. In particular example embodiments, some or all of the functionality of the UE is provided by the UE processor 24 executing instructions stored on a computer-readable medium, such as the one or more memories 26. Alternative embodiments of the UE may include additional components beyond those shown that may provide certain aspects of the UE's functionality.

FIG. 5 is a diagram illustrating non-limiting example function block elements for a base station 12. Examples of base stations include RBSs, home base stations, pico base stations, Node Bs, eNodeBs, etc. The base station is one example of a radio network node that may employ a precoder to prepare signals for MIMO transmission. Other example radio network nodes include a radio network controller (RNC), a base station controller (BSC), a relay, etc. The example base station 12 is shown as having a main portion 30 and a remote portion 32 that is mounted on a pole or tower and is connected for communication with the main unit 30 via cable or some other suitable link. The main unit 30 includes one or more processors 38, one or more memories 40, and one or more network interfaces 42. The one or more processors 38 may selectively implement one or more different precoders in hardware alone or a combination of hardware and software to prepare signals for MIMO communication. The remote unit includes one or more transceivers having one or more power amplifiers (PA(s)) that are coupled to multiple antennas 34. the In particular example embodiments, some or all of the base station functionality may be provided by the base station processor executing instructions stored on a computer-readable medium, such as one or more memories 40.

Initially, a MIMO signal transmitted from a radio network node using multiple antennas as received by a UE is defined. For simplicity, the radio network node is assumed to use two transmit antennas. But the principles described may be extended configurations using more than two transmit antennas at the radio network node. The signal at the output of the radio network node transmit antennas 1 and 2 (y₁ and y₂, respectively) can be written as follows:

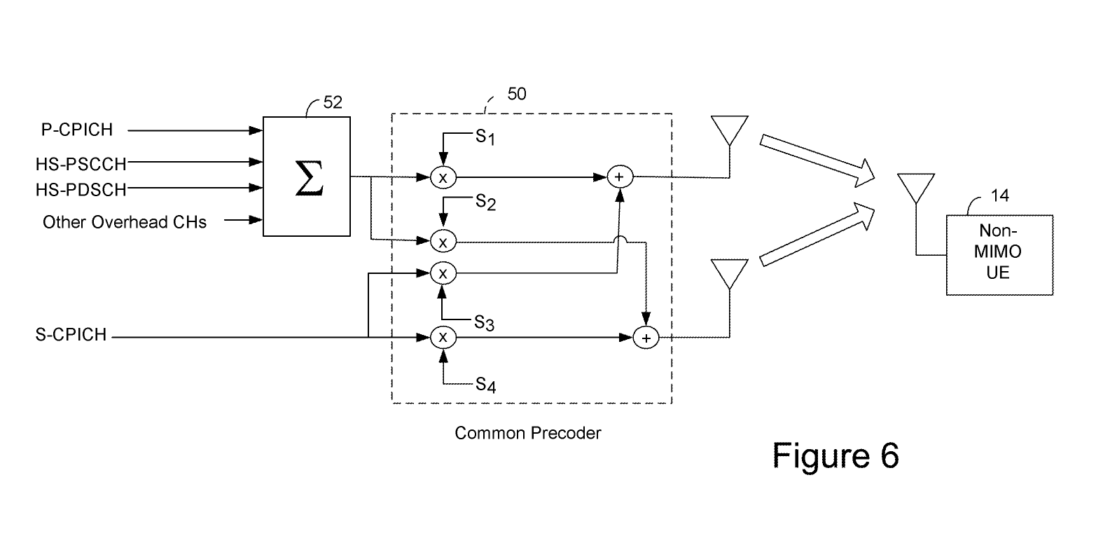

y₁=x₁s₁+x₂s₃,y₂=x₁s₂+x₂s₄ (4)

where x1 and x2 are input signals of a common precoder device 50 shown in FIG. 6. The common precoder 50 includes precoder weights S₁-S₄, where:

S₁=A₁e^{jα},S₂=A₂e^{jø},S₃=A₃e^{jβ}, and S₄=A₄e^{jθ} (5)

and α, β, φ, and θ are phase values.

Without loss of generality, consider that:

x₁=xₚ+dₚ,x₂=xₛ+dₛ (6)

where xₚ is the P-CPICH signal, dₚ is the HS-PDSCH₁, xₛ is the S-CPICH signal and dₛ is the HS-PDSCH₂, where HS-PDSCH₁ and HS-PDSCH₂ are the 2 MIMO transmitted streams. Substituting in various ones of the equations above yields:

y₁=(\sqrt{Pₚ}xₚ+\sqrt{P_{d}}dₚ)e^{jα}+(\sqrt{Pₛ}xₛ+\sqrt{P_{d}}dₛ)e^{jβ}

y₂=(\sqrt{Pₚ}xₚ+\sqrt{P_{d}}dₚ)e^{jφ}+(\sqrt{Pₛ}xₛ+\sqrt{P_{d}}dₛ)e^{jθ}

Call hₙₘ the channel from antenna ‘n’ to antenna ‘m’. To simplify the mathematical computation, consider a single tap fading channel. The rationale can be extended to frequency selective fading. The received signals r₁ and r₂ at the UE's MIMO antennas 1 and 2 can be expressed as follows:

r₁=y₁h₁₁+y₂h₂₁,r₂=y₂h₂₂+y₁h₁₂

r₁=└(\sqrt{Pₚ}xₚ+\sqrt{P_{d}}dₚ)e^{jα}+(\sqrt{Pₛ}xₛ+\sqrt{P_{d}}dₛ)e^{jβ}┘h₁₁+[(\sqrt{Pₚ}xₚ+\sqrt{P_{d}}dₚ)e^{jφ}+(\sqrt{Pₛ}xₛ+\sqrt{P_{d}}dₛ)e^{jθ]h}₂₁=\sqrt{Pₚ}xₚ(e^{jα}h₁₁+e^{jφ}h₂₁)+\sqrt{Pₛ}xₛ(e^{jβ}h₁₁+e^{jθ}h₂₁)+\sqrt{P_{d}}dₚ(e^{jα}h₁₁+e^{jφ}h₂₁)+\sqrt{P_{d}}dₛ(e^{jβ}h₁₁+e^{jθ}h₂₁) (7)

r₂=└(\sqrt{Pₚ}xₚ+\sqrt{P_{d}}dₚ)e^{jα}+(\sqrt{Pₛ}xₛ+\sqrt{P_{d}}dₛ)e^{jβ}┘h₁₂+[(\sqrt{Pₚ}xₚ+\sqrt{P_{d}}dₚ)e^{jφ}+(\sqrt{Pₛ}xₛ+\sqrt{P_{d}}dₛ)e^{jθ]h}₂₁=\sqrt{Pₚ}xₚ(e^{jα}h₁₂+e^{jφ}h₂₂)+\sqrt{Pₛ}xₛ(e^{jβ}h₁₂+e^{jθ}h₂₂)+\sqrt{P_{d}}dₚ(e^{jα}h₁₂+e^{jφ}h₂₂)+\sqrt{P_{d}}dₛ(e^{jβ}h₁₂+e^{jθ}h₂₂) (8)

In the common precoder 50 in FIG. 6, the power is balanced between the two base station antennas, i.e., the two antennas transmit the same or substantially the same power. In other words, the values of A1, A2, A3, A4, α, β, φ, and θ are selected so that the power is balanced. This balance may be described mathematically as a constant modulus matrix, which is a matrix whose elements have the same absolute value |hᵢⱼ|=a, with ‘a’ being constant for each ‘i’, ‘j’. Other values of A1, A2, A3, A4, α, β, φ, and θ than those that balance the power define an un-common precoder.

Another way to define a precoder is by using functions (not necessarily multiplications): f1(S₁,d1), f2(S₂,d1) f3(S₃,d2), f4(S₄,d2), where f1 is a function that provides a certain operation between the weighting signal S and the input signal d. In the non-limiting example of FIG. 6 in a WCMA context, the primary pilot (P-CPICH), high speed shared control channel (HS-SCCH), high speed physical downlink channel (HS-PDSCH), and other overhead channels (CHs) are combined in combiner 52 to generate input signal d1, and the secondary pilot channel (S-CPICH) corresponds to input signal d2. Although the transmitted signals are shown being received by a non-MIMO UE in FIG. 6, they may also be received by a MIMO UE. This is because the scheme is applicable to MIMO and non-MIMO UEs such as legacy UEs. As a result, both MIMO and non-MIMO UEs may be served by the same arrangement in the base station. This also avoids having a separate setup for MIMO UEs and non-MIMO UEs.

Thus, a common precoder is one in which:

∥f1(s1,d1)+f3(s3,d2)|²=11f2(s2,d1)+f4(s3,d2)∥²

i.e., the same power or substantially the same power on both MIMO transmit antennas.

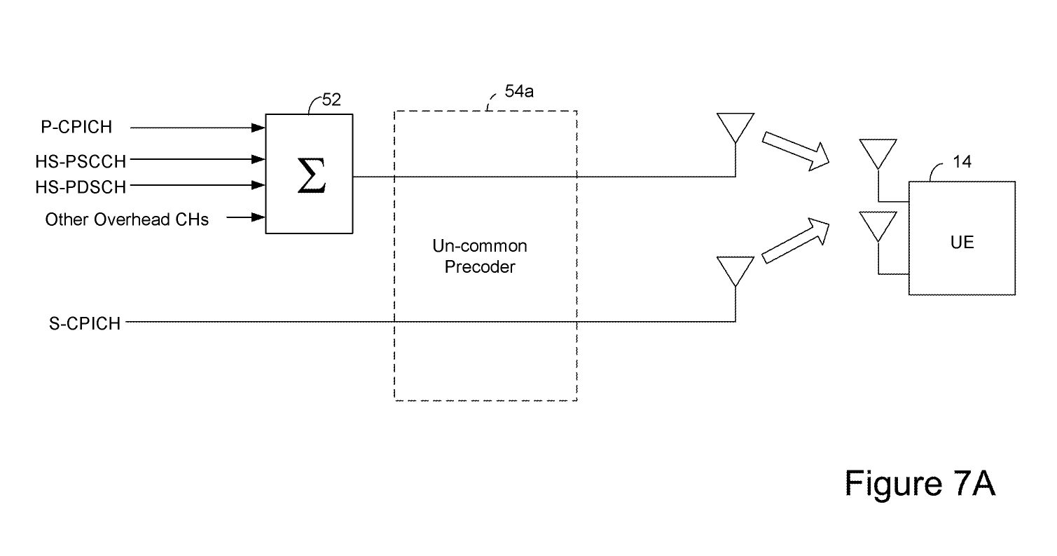

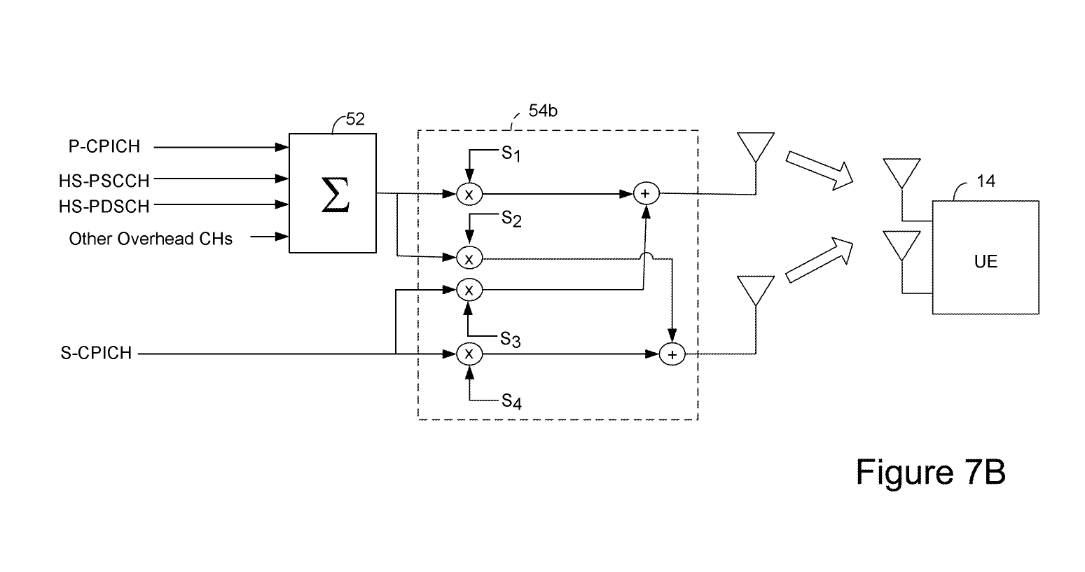

FIGS. 7A and 7B are non-limiting examples of uncommon precoders. In the uncommon precoder 54a in FIG. 7A, there is no weighting to balance the antenna powers. The uncommon precoder 54b in FIG. 7B has values for S₁-S₄ that lead to an imbalance of power between the two antennas.

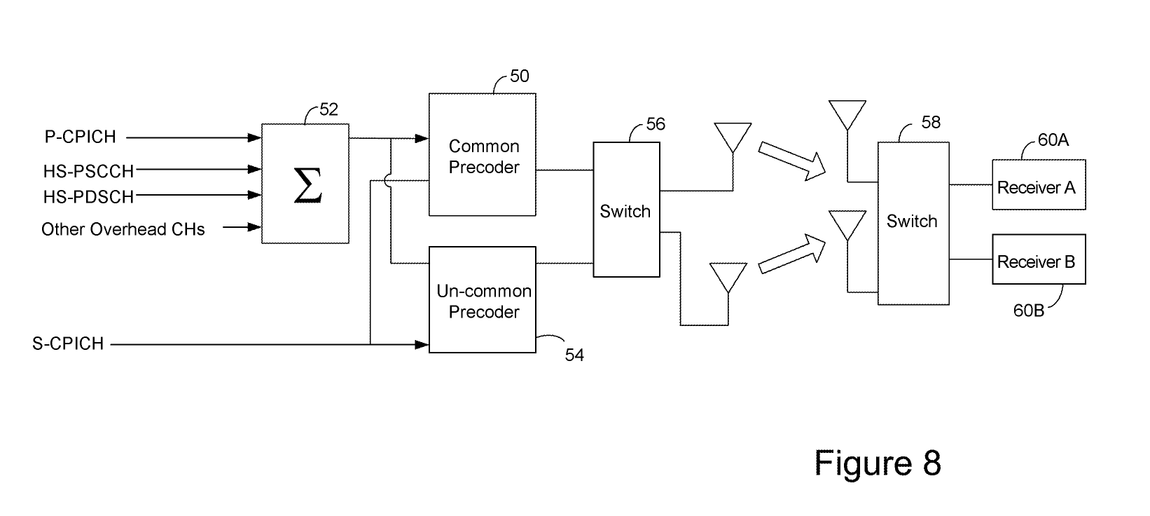

FIG. 8 is a non-limiting example of a radio network node, e.g., a base station, with selectable common and uncommon precoders 50 and 54 respectively, and a UE with selectable receivers A and B labeled as 60A and 60B, respectively. The precoders 50 and 54 are coupled to a switch 56, which is controlled by the BS processor 38 (not shown in this figure) to select one of them to precode the signals prior to MIMO transmission. The different receivers 60A and 60B are coupled to a switch 58 and differ for example in complexity, robustness, accuracy, power demands, processing demands, and/or performance. The UE processor 24 selects one of the first receiver 60A and a second receiver 60B by controlling the switch 58 based on the precoder being used in the radio network node. This allows the UE to use the type of receiver (or receiver parameters, receiver configuration, etc.) best suited to the precoder being used.

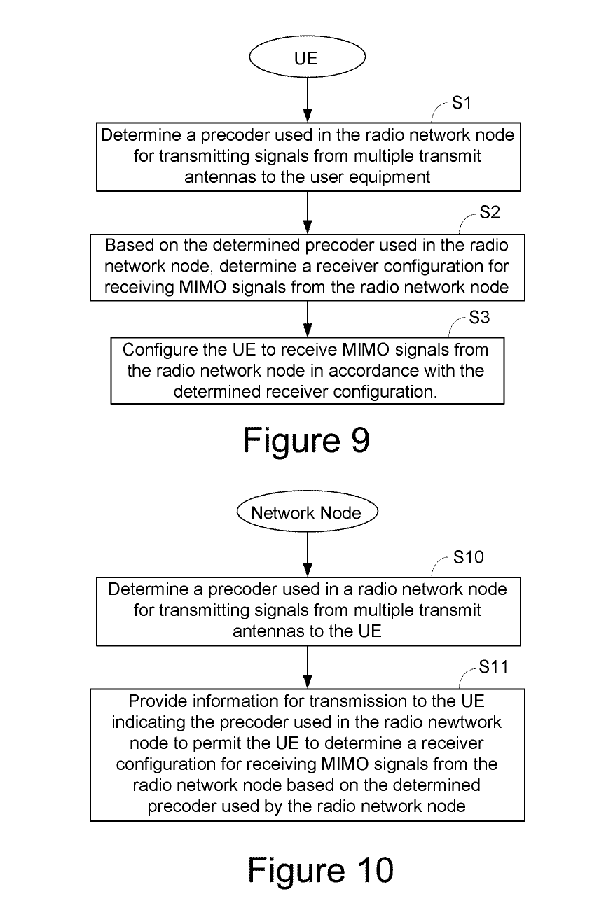

FIG. 9 is a flowchart illustrating non-limiting example procedures in accordance with one example embodiment followed by a UE configured to perform multiple input multiple output (MIMO) communications with a radio network node that includes multiple MIMO branches. Each MIMO branch includes a power amplifier and an antenna. The UE determines a precoder used in the radio network node for transmitting signals from multiple transmit antennas to the UE (step S1). Based on the determined precoder used in the radio network node, the UE determines a receiver configuration for receiving MIMO signals from the radio network node (step S2). The UE then configures its receiving circuitry to receive MIMO signals from the radio network node in accordance with the determined receiver configuration (step S3).

Various example methods are now described for adapting or selecting an appropriate receiver type in the UE based on the precoder in the radio network node. In one example embodiment, the UE receives a parameter “Common Precoder Index” value of 1 or 0 or any suitable indicator transmitted by the BS as described above and adapts the receiver parameters based on the knowledge of the network node precoder. The adapted receiver parameters may then be used for receiving various types of signals (e.g., data and control information) from the radio network node. Alternatively, the UE may also use the adapted receiver for receiving only certain types of signals, e.g., only data and/or important signals such as power control commands, etc.

If a common precoder is being used, then the accuracy of signals between MIMO transmit branches is generally very good. More specifically, the accuracy of the relative power offset between the S-CPICH transmit power and P-CPICH transmit power in the example in FIG. 6 can be on the order of ±1 dB. The P-CPICH transmit power is signaled to the UE. This additional information corresponding to relative power offset between S-CPICH and P-CPICH power can also be signaled to the UE. The UE may exploit that information to optimize UE receiver parameters by assuming a certain power level of the S-CPICH. For example, if the UE knows that the S-CPICH power level is accurate, the UE can assume Pₛ to be known without having to estimate Pₛ (see Equation (7) and (8)), hence reducing the complexity in the UE.

In one example embodiment, the UE configures its receiver or chooses a receiver to increase the receiver performance (albeit at the same complexity) if the radio network node uses a common precoder. In another example embodiment, the UE reduces receiver complexity by avoiding power measurements on the S-CPICH channel when the UE knows that the radio network node is using a common precoder.

Typically, if a common precoder is used, then the UE selects a receiver type that involves less complexity or is less robust (because the UE can make accurate assumptions on power levels) or that achieves higher performance. The reason is that a common precoder ensures better accuracy of the signals transmitted by the radio network node. On the other hand, when a common precoder is not used by the radio network node, then the UE may select a receiver type which is more robust and/or complex. This helps to ensure that the received signal quality (e.g., SINR, BLER, throughput etc) is not degraded due to relative less stringent accuracy of the signals transmitted by the BS. A more complex receiver involves more processing and higher power consumption.

In yet another example embodiment, the UE selects receiver type A if common precodor is used otherwise it selects receiver type B. Receiver type A is less robust and simpler and may also involve less processing, thereby also potentially consuming less power with longer battery life. On the other hand, receiver type B employs more complex computations and processing and is capable of demodulating less accurate signals. The drawback is that it may consume more power leading to shorter battery life.

The acquired knowledge about the precoder used by the radio network node may include the presence of the common precoder knowledge of used precoder weights or phases (e.g., S₁, S₂, S₃, S₄) obtained via signalling as described below in order to improve the reception of the signal transmitted by the radio network node via multiple antennas.

In another example embodiment, a UE detects precoder weights used by a radio network node to implement the precoder used for transmitting signals. The UE can detect the weights if the UE knows that a common precoder is used. This information can be acquired by the UE by receiving an indicator from the radio network node, e.g., after reception of ‘Common Precoder Indicator’=1, or by acquiring any relevant information or indicator which reveals that common precoder is used. The UE may, using any suitable channel estimation algorithm, estimate the following composite channels:

ĥ_{A}=(e^{jα}h₁₁+e^{jφ}h₂₁) and ĥ_{B}=(e^{jβ}h₁₁+e^{jθ}h₂₁)

from the first antenna, and

ĥ_{C}=(e^{jα}h₁₂+e^{1φ}h₂₂) and ĥ_{D}(e^{jβ}h₁₂+e^{jθ}h₂₂)

from the second antenna. Based on the UE's estimation of these 4 composite channels, h_{A}-h_{D}, the UE can estimate the precoder weight values as phases S₁=exp(jα), S₂=exp(jφ), S₃=exp(jβ) and S₄=exp(jθ). Alternatively, the radio network node can signal to the UE information about precoder weights used.

Consider Equations (7) and (8). By exploiting the fact that xₚ and xₛ are known and orthogonal between each other and orthogonal with respect to the input signals dₚ and dₛ, and by exploiting the fact that the precoder weights S₁, S₂, S₃, S₄ signals are known, the 4 channel estimations based on antenna 1 and signal xₚ, antenna 1 and signal xₛ, antenna 2 and signal xₚ and antenna 2 and signal xₛ can be combined. The UE combines the channel estimations in order to improve the quality of received signal and to improve the overall receiver performance. The channel estimation may be performed on any known (pilot) signal, e.g., common pilot signals, sychronization signals, dedicated pilot signals, etc. In another example embodiment, the UE performs only 2 channel estimations rather than 4 channel estimations in the example in in order to reduce complexity.

The UE can acquire this information in connected mode or active mode, but the UE may also acquire this information in idle mode or in other low activity states. Non-limiting examples of low activity states are dormant, URA_PCH, CELL_PCH, CELL_FACH, etc.

FIG. 10 is a flowchart illustrating non-limiting example procedures in accordance with one example embodiment followed by a network node for facilitating MIMO communications with a UE. The network node determines a precoder used in a radio network node for transmitting signals from multiple transmit antennas to the UE (step S 10). The network node provides information for transmission to the UE indicating the precoder used in the radio network node to permit the UE to determine a receiver configuration for receiving MIMO signals from the radio network node based on the determined precoder used by the radio network node (step S 11).

Non-limiting example embodiments are now described for the radio network node to signal its currently used precoder to the UE. For example, the network node signals to the UE an indicator which depicts the type of the precoder used by the base station transmitter with multiple antennas. The indicator can depict for example whether the common precoder is used or not. A non-limiting example of precoder signaling or a precoder indicator is a Boolean value (1/0). The parameter name can be labeled as “Common Precoder Indicator,” where a value of 1 corresponds to a common precoder being used and a value of 0 corresponds to the common precoder not being used. Of course, the values could be reversed.

The signaling or indicator may include additional bits or information indicating further details about the precoder used. Some examples of additional information include the time period over which the signaled information is valued. Such a valid time period can be useful for instance in case the network may change the type of precoder on a semi-static basis, when the radio network node is modified or upgraded, or when one or more antennas are turned off or on. Another example of additional information includes a power difference or offset between signals transmitted by the radio network node when a common precoder is used (or not used). By default, the power difference can for example be the same for a common precoder and an un-common precoder. Advantageously, only 1 bit or a limited number of bits, i.e., small signaling overhead, is needed to signal the use of common precoder.

The above signaling (an indicator, and if necessary or desired, some additional information) may be sent over a suitable control channel. The signaling can be higher protocol layer signaling such as radio resource control (RRC) layer signaling or lower protocol layer signaling such as L1, MAC, etc., or a combination thereof. The higher and/or lower layer signaling message(s) can be mapped onto a suitable common control or data channel or a UE-specific control or data channel. Several non-limiting examples are given including a broadcast channel (a common control channel) or the HS-SCCH, DCH, FACH, HS-PDSCH in WCDMA or the PDSCH, PDCCH in LTE.

One or multiple network nodes may be involved in signaling precoder use information to the UE. For instance, in High Speed Packet Access (HSPA), the radio network controller (RNC) may signal part or all of the precoder indicator or information to the UE. In another example, the radio network node (e.g., base station) may signal the information to the UE. In case part of precoder information is signaled by the RNC, the remaining precoder information can be signaled by the base station to the UE. For example, partial information can be N set of phases preconfigured in the UE. The remaining information can be an identifier of the set of phases currently used by the base station. In another example, the base station may signal all of the precoder information to the UE.

Such precoder information may also be signaled to other network nodes. For example, each base station may signal an indicator corresponding to the precoder being used to the RNC over Iub interface in HSPA. In LTE, each eNB may signal a precoder indicator to other eNBs over the X2 interface. This precoder information can be used by a serving node (e.g., an RNC, etc.) to signal the precoder information about one or more the neighbor cells at the time of a handover.

In another example embodiment, a network node shares a codebook f phase values with the UE. The codebook is a uniform representation of the unit circle in terms of phases (example 0, π/2^{N-1}, 2π/2^{N-1}, . . . , 2π). This codebook requires 4×log₂ 2^{N}=4N bits. The network node first transmits, for each element of the precoder, an index of the precoder codebook such that its centroid is the closest to the real value used.

In another example embodiment, a network node further applies a successive refinement algorithm where quantized information is refined at each step by quantizing the same common precoder element but considering the hypothesis that the UE has the information about the centroid which is the closest to the real value at previous step. As an example, call the index of the centroid for signal s₁ ‘i’. The network node refines the quantization by applying the same codebook on the ‘i’-th quantization bin. Since the transmitted information (common precoder index) may be constant, this algorithm converges to 0 quantization error.

In another example embodiment, the precoder weights are equal, e.g., S₁=S₂=S₃=S₄. In that case, only N bits need be used in any of the above embodiments for transmitting common precoder information.

In yet another example embodiment, the network node is constrained to use a certain fixed set of precoder phases equal to the quantization codebook. Alternatively, the network node can change dynamically these phases to increase channel diversity. In this case, the network node signals the information to the UE about the modified precoder weights, e.g., phases.

In addition to the examples described above for signaling the precoder information, the network node may signal an indicator or identifier corresponding to a pre-defined set of precoder weights. In one example with 4 sets of pre-defined weights, 2 bits are signaled to identify the weights used. This approach reduces the signaling overheads. In another example, the network pre-configures the UE with more than one set of weights, e.g. via higher layer signaling. Then, the network sends an identifier corresponding to the set of weights currently used in the radio network node.

The technology is applicable to UEs and network nodes supporting any type of radio access technology (RAT) (e.g., LTE, HSPA, GSM, CDMA2000, HRPD, WiMax, etc.) or supporting technology which comprises of a mixture of RATs (e.g., a multi-standard radio (MSR)). The technology is also applicable to UEs and network nodes that support carrier aggregation (CA), multi-carrier, multi-carrier-multi-RAT with multiple transmit antenna operation, e.g., beamforming, MIMO, transmit diversity, etc. Examples of CA include DC-HSDPA, DC-HSUPA, 4C-HSDPA, 8C-HSDPA, DB-DC-HSDPA in HSPA, etc.

Although the description above contains many specifics, they should not be construed as limiting but as merely providing illustrations of some presently preferred embodiments. The technology fully encompasses other embodiments which may become apparent to those skilled in the art. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed hereby. Moreover, it is not necessary for a device or method to address each and every problem sought to be solved by the described technology for it to be encompassed hereby.

1. A method implemented in a user equipment, UE, radio node configured to perform multiple input multiple output, MIMO, communications with a radio network node that includes multiple MIMO branches, each MIMO branch including a power amplifier and an antenna, the method comprising:
determining a precoder used in the radio network node for transmitting signals from multiple transmit antennas to the user equipment;
based on the determined precoder used in the radio network node, determining receiver parameters for receiving MIMO signals from the radio network node; and
configuring the UE to receive MIMO signals from the radio network node in accordance with the determined receiver parameters.

2. The method in claim 1, wherein the determining of the precoder used in the radio network node includes whether the radio network node uses a common precoder that enables each of the MIMO branches to transmit with the same power.

3. The method in claim 1, wherein the determining of the precoder used in the radio network node includes whether the radio network node uses a common precoder that enables each of the MIMO branches to transmit with a different power or with a power offset between MIMO signals transmitted by the radio network node.

4. The method in claim 2, further comprising: receiving a message indicating whether the radio network node is using the common precoder in MIMO transmissions.

5. The method in claim 4, wherein the message indicates the precoder used in a serving radio network node and/or a neighboring radio network node.

6. The method in claim 4, wherein the message further includes a time period associated with using the common precoder in the radio network node.

7. The method in claim 4, further comprising receiving the message over a control channel or a data channel.

8. The method in claim 4, wherein the message originates from one or more network nodes including the radio network node, a radio network controller, a base station controller, base station, Node B, eNode B, or a relay node.

9. The method in claim 1, wherein the determining includes estimating precoder weights used by the network node based on channel estimates.

10. The method in claim 1, wherein the UE includes a first type of receiver and a second type of receiver that is more robust and/or more accurate than the first type of receiver, and wherein the configuring the UE to receive MIMO signals from the radio network node in accordance with the determined receiver parameters includes selecting one of the first receiver and a second receiver.

11. The method in claim 10, further comprising selecting the first receiver to receive MIMO signals from the network node if the network node is using a common precoder, and otherwise selecting the second receiver to receive MIMO signals from the network node if the network node is not using a common precoder.

12. The method in claim 1, further comprising improving reception of the received MIMO signals from the network node using the determined precoder used by the radio network node.

13. A method implemented in a network node for facilitating multiple input multiple output, MIMO, communications with a user equipment, UE, radio node, the method comprising:
determining a precoder used in a radio network node for transmitting signals from multiple transmit antennas to the UE, and
providing information for transmission to the UE indicating the precoder used in the radio network node to permit the UE to determine a receiver configuration for receiving MIMO signals from the radio network node based on the determined precoder used by the radio network node.

14. The method in claim 13, wherein the step of determining a precoder used in a radio network node includes receiving information from the radio network node.

15. The method in claim 14, wherein the radio network node sending the precoder used in the radio network node is a serving radio network node and/or a neighboring radio network node of the UE.

16. The method in claim 13, wherein the information is provided by one or more of a radio network controller, the radio network node, or another radio network node.

17. The method in claim 13, wherein the radio network node includes multiple MIMO branches, each MIMO branch including a power amplifier and an antenna, and wherein the determining includes determining whether the radio network node is using a common precoder that enables the each of the MIMO branches to transmit with the same power.

18. The method in claim 13, wherein the radio network node includes multiple MIMO branches, each MIMO branch including a power amplifier and an antenna, and wherein the determining includes determining whether the radio network node is using a common precoder that enables the each of the MIMO branches to transmit with a power offset between the MIMO branches.

19. The method in claim 13, wherein the providing includes providing information regarding precoding weights of the precoder.

20. The method in claim 13, wherein the providing includes providing information regarding codebook information associated with the precoder.

21. The method in claim 13, further comprising sending the information indicating the precoder used in the radio network node to the UE using one or both of communications protocol layer 3 or above signaling and communications protocol layer 1 or communications protocol layer 2 signaling.

22. The method in claim 13, further comprising:
sending to the UE configuration information including multiple different precoding capabilities, and
subsequently sending to the UE an identifier to identify one of the multiple precoding capabilities currently in use by the network node.

23. The method in claim 13, wherein the network node is one of a radio network controller, a radio base station, a base station controller, a Node B, an eNode B, or a relay node.

24. Apparatus useable in a user equipment, UE, radio node configured to perform multiple input multiple output, MIMO, communications with a radio network node that includes multiple MIMO branches, each MIMO branch including a power amplifier and an antenna, the apparatus comprising processing circuitry configured to:
determine a precoder used in the radio network node for transmitting signals from multiple transmit antennas to the user equipment;
based on the determined precoder used in the radio network node, determine one or more receiver parameters for receiving MIMO signals from the radio network node; and
configure UE receiving circuitry to receive MIMO signals from the radio network node in accordance with the determined one or more receiver parameters.

25. The apparatus in claim 25, wherein the processing circuitry is configured to determine whether the radio network node uses a common precoder that enables each of the MIMO branches to transmit with the same power.

26. The apparatus in claim 25, wherein the processing circuitry is configured to determine whether the radio network node uses a common precoder that enables each of the MIMO branches to transmit with a different power or with a power offset between MIMO signals transmitted by the radio network node.

27. The apparatus in claim 25, further comprising a receiver configured to receive a message indicating whether the radio network node is using the common precoder in MIMO transmissions.

28. The apparatus in claim 27, wherein the message further includes a time period associated with using the common precoder in the radio network node.

30. The apparatus in claim 27, wherein the receiver is configured to receive the message over a control channel or a data channel.

31. The apparatus in claim 24, wherein the processing circuitry is configured to estimate precoder weights used by the network node based on channel estimates.

32. The apparatus in claim 24, wherein the UE includes a first type of receiver and a second type of receiver that is more robust and/or more accurate than the first type of receiver, and wherein the processing circuitry is configured to select one of the first receiver and a second receiver in accordance with the determined receiver configuration.

33. The apparatus in claim 32, wherein the processing circuitry is configured to select the first receiver to receive MIMO signals from the network node if the network node is using a common precoder, and otherwise select the second receiver to receive MIMO signals from the network node if the network node is not using a common precoder.

34. A user equipment comprising the apparatus of claim 24.

35. Apparatus useable in a network node for facilitating multiple input multiple output, MIMO, communications with a user equipment, UE, radio node, the apparatus comprising processing circuitry configured to:
determine a precoder used in a radio network node for transmitting signals from multiple transmit antennas to the UE, and
provide information for transmission to the UE indicating the precoder used in the radio network node to permit the UE to determine a receiver configuration for receiving MIMO signals from the radio network node based on the determined precoder used by the radio network node.

36. The apparatus in claim 35, wherein the radio network node includes multiple MIMO branches, each MIMO branch including a power amplifier and an antenna, and wherein the processing circuitry is configured to determine whether the radio network node is using a common precoder that enables the each of the MIMO branches to transmit with the same power.

37. The apparatus in claim 35, wherein the radio network node includes multiple MIMO branches, each MIMO branch including a power amplifier and an antenna, and wherein the processing circuitry is configured to determine whether the radio network node is using a common precoder that enables the each of the MIMO branches to transmit with a power offset between the MIMO branches.

38. The apparatus in claim 35, wherein the processing circuitry is configured to provide information regarding precoding weights of the precoder or codebook information associated with the precoder.

39. The apparatus in claim 35, wherein the processing circuitry is configured to send the information indicating the precoder used in the radio network node to the UE using one or both of communications protocol layer 3 or above signaling and communications protocol layer 1 or communications protocol layer 2 signaling.

40. The apparatus in claim 35, wherein the network node is one of a radio network controller, a radio base station, a base station controller, a Node B, an eNode B, or a relay node.
